(19) United States
(12) Patent Application Publication
(10) Pub. No.: US 2006/0153649 A1
(43) Pub. Date: Jul. 13, 2006

(54) Particle loading system

(76) Inventors: Robert H. Folstadt JR., Rockwall, TX (US); James D. Ballard JR., Rockwall, TX (US)

Correspondence Address: John A. Thomas;L.B. 48, 13355 Noel Road, Dallas, TX, 75240-1518, US

(21) Appl. No.: 11/031,865

(22) Filed: Jan. 7, 2005

(51) Int. Cl. B65G 53/50

(52) U.S. Cl. 406/144

(57) ABSTRACT

A particle-loading system has a hopper for particles. The hopper is connected to a funnel that is further connected to a flow chamber for receiving particles from the hopper. The system has a venturi. The venturi has an outlet that is positioned to open into the flow chamber. The venturi further comprises an inlet, for connection to a source of pressurized gas, and an outlet. The outlet has a V-shaped cross-section that as a crotch between the arms of the V-shape. A secondary venturi is located in and opens into the crotch of the V-shape. The flow chamber is connected to an exit pipe, for directing the flow of air and particles away from the system.

### TECHNICAL FIELD

The present disclosure relates to systems for conveying animal feed, or any substance composed of light particles, by a directed flow of air to a remote location.

### BACKGROUND

A concern of those interested in promoting animal populations for recreational hunting is the supplementation of food supplies during those times when naturally occurring forage is not adequate to support dependent animal populations. This is especially true during the fall and winter months; the time for most recreational hunting.

Over the years, automated remote animal feeders have been developed which are intended to automatically dispense a predetermined quantity of feed over a given time. Animal feeders are usually elevated above a height where there might be interference by a foraging animal. Such animal feeders may be wind powered or powered by small electric devices using batteries. While these feeding systems are efficient at dispensing the feed, the feeding systems have to be periodically recharged manually with feed.

Loading an elevated animal feeder in a remote field location is generally done by carrying bagged feed up a ladder, lifting the heavy bag above the user's shoulders and manually dumping the contents into the hopper of the feeder.

There is a need for an efficient and safe way to load these elevated animal feeding systems. What is needed is a system that can rapidly move feed from ground level into an elevated hopper. Such a system should be adaptable to the loading of any elevated container with light-weight particles.

### SUMMARY

A particle-loading system has a hopper for particles. The hopper is connected to a funnel that is further connected to a flow chamber for receiving particles from the hopper. The system has a venturi. The venturi has an outlet that is positioned to open into the flow chamber. The venturi further comprises an inlet, for connection to a source of pressurized gas, and an outlet. The outlet has a V-shaped cross-section that as a crotch between the arms of the V-shape. A secondary venturi is located in and opens into the crotch of the V-shape. The flow chamber is connected to an exit pipe, for directing the flow of air and particles away from the system.

This disclosure uses the example of lifting feed to an animal feeder, but the reader should note that the claims are not so limited, and embodiments may be used to propel many other light-weight particles as well, such as seeds, fertilizers, or pesticides in agricultural use, pulverized solid fuels, or packaging material.

### DRAWINGS

FIG. 1 is a perspective view of the venturi of the preferred embodiment.

FIG. 2 is a side view in partial cross-section of the assembled particle loading system.

FIG. 3 is a side view in cross-section of the venturi and a front view of the outlet of the venturi.

### DETAILED DESCRIPTION

In the preferred embodiment, the particle-loading system has a venturi that accepts pressurized air in its inlet and accelerates particles that fall into the air stream at the outlet of the venturi.

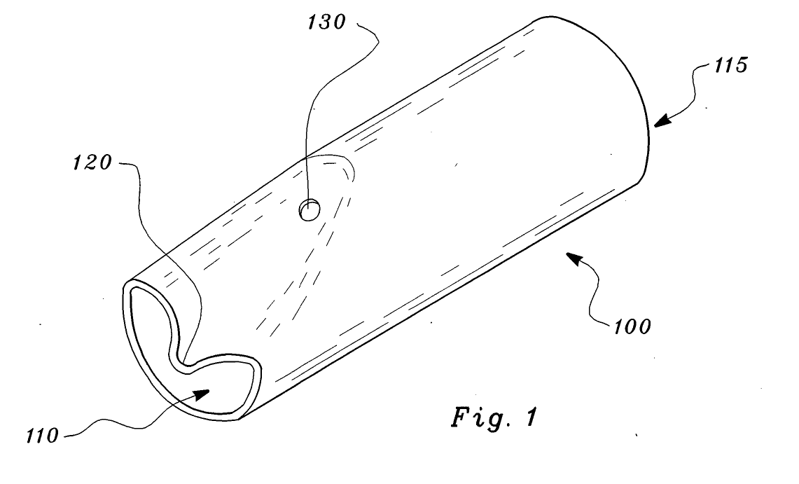

FIG. 1 shows the venturi (100) of the preferred embodiment. The venturi (100) has an outlet (110) and an inlet (115) for pressurized air. The source of pressurized air is not shown, and may be a conventional blower. The venturi (100) has a substantially V-shaped cross-section (120) at its outlet (110), and a secondary venturi (130) placed in the crotch (125) of the V-shape (120), as depicted. The secondary venturi (130) insures the agitation and separation of the particles (140) falling by gravity into the vicinity of the venturi outlet (110). The term “V-shaped” is meant to describe a cross-section that substantially divides the air flow from the outlet (110) into two parallel streams, and covers similar shapes, such as the stylized heart shape.

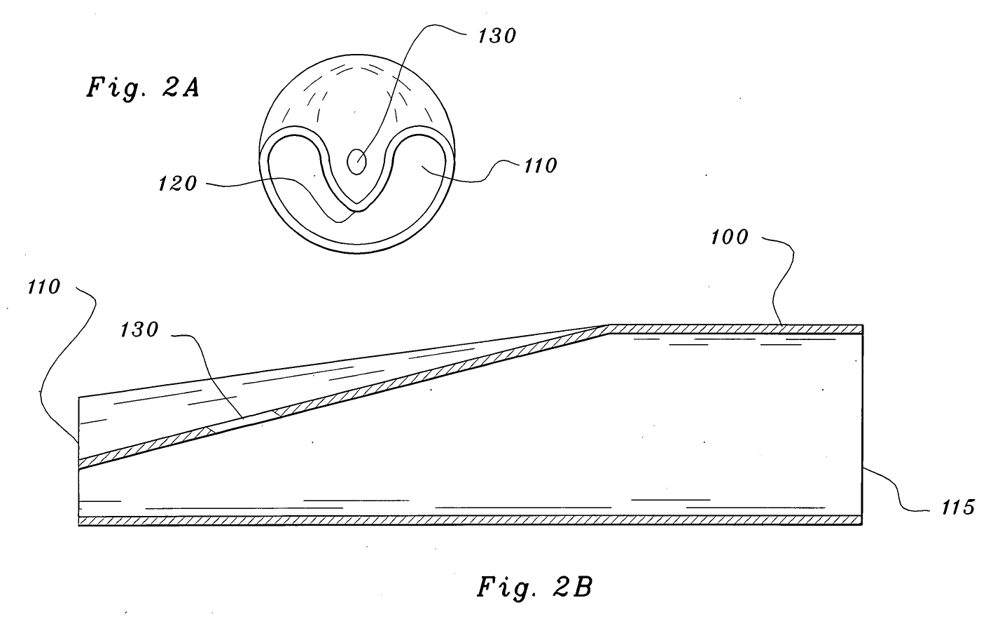

FIG. 2 shows the assembled system of the preferred embodiment. A hopper (150) to hold the supply of light particles (140). A funnel (160) connects the hopper (150) to a flow chamber (170). The venturi (100) is placed within the flow chamber (170) so that its outlet (110) is below the particles (140) falling from the funnel (160). The agitated and accelerated particles through an exit pipe (180). The exit pipe (180) is of course connected to piping (not shown) that directs the accelerated particles (140) up and into the elevated hopper or container desired to be filled. In the illustrated embodiment, the particles (140) fall by gravity to the flow chamber (170), but conventional auger-feed methods could be used in larger systems.

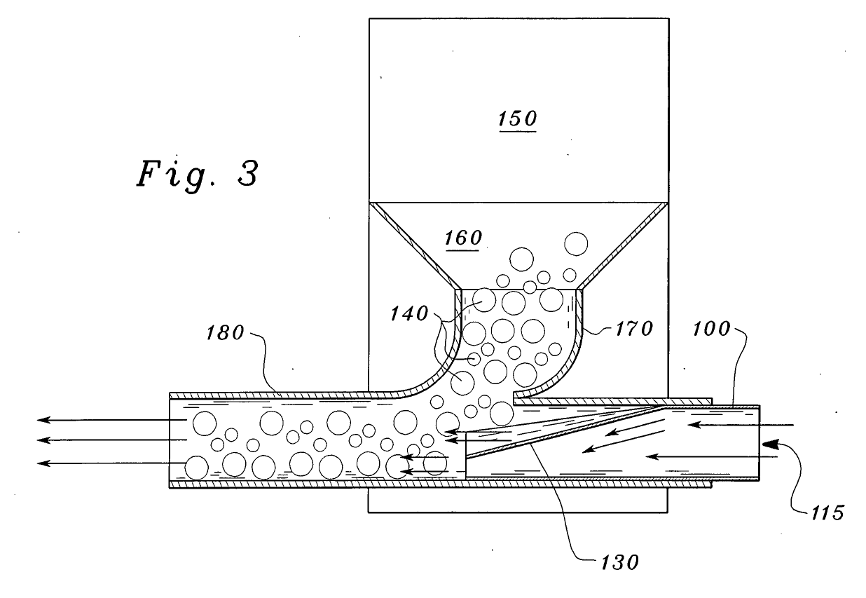

FIG. 3 shows more detail of the venturi (100). FIG. 3A is a cross-section of the outlet end of the venturi (100), showing the V-shape of its cross-section and the particle-agitating secondary venturi (130) situated in the crotch (125) of the venturi outlet (110). FIG. 3B is a side-view in partial cross-section of the venturi (100). The venturi (100) is preferably made of light-wall steel tubing, although any rigid material would be suitable.

Since those skilled in the art can modify the specific embodiments described above, We intend that the claims be interpreted to cover such modifications and equivalents.

We claim:

1. A venturi for accelerating particles, the venturi comprising:
an inlet for pressurized gas;
an outlet;
the outlet having a V-shaped cross-section, and;
a secondary venturi located in the crotch of the V-shape of the outlet.

2. A particle-loading system, the system comprising:
a hopper for particles;
the hopper connected to a flow chamber;
a venturi, the venturi having an outlet;
the outlet positioned to open into the flow chamber;
the venturi further comprising:
a V-shaped outlet, the V-shaped outlet having a crotch, and;
a secondary venturi located in the crotch.

3. The particle-loading system of claim 2, further comprising a funnel connected between the hopper and the flow chamber.

4. The particle-loading system of claim 2 where the venturi has an inlet for connection to a source of pressurized gas.

5. The particle-loading system of claim 2 where the flow chamber is connected to an exit pipe, for directing the flow of air and particles away from the system.

6. A particle-loading system, the system comprising:
a hopper for particles;
the hopper connected to a funnel;
the funnel connected to a flow chamber;
a venturi, the venturi having an outlet;
the outlet positioned to open into the flow chamber;
the venturi further comprising:
an inlet, for connection to a source of pressurized gas;
a V-shaped outlet, the V-shaped outlet having a crotch;
a secondary venturi located in the crotch; and,
the flow chamber connected to an exit pipe, for directing the flow of air and particles away from the system.
